(19) United States
(12) Patent Application Publication
(10) Pub. No.: US 2015/0167717 A1
(43) Pub. Date: Jun. 18, 2015

(54) ALIGNMENT AND RETENTION SYSTEM FOR PROVIDING PRECISE ALIGNMENT AND RETENTION OF COMPONENTS

(71) Applicant: GM Global Technology Operations LLC, Detroit, MI (US)

(72) Inventors: Steven E. Morris, Fair Haven, MI (US); Jennifer P. Lawall, Waterford, MI (US)

(73) Assignee: GM GLOBAL TECHNOLOGY OPERATIONS LLC, Detroit, MI (US)

(21) Appl. No.: 14/104,541

(22) Filed: Dec. 12, 2013

(51) Int. Cl. F16B 21/07

(52) U.S. Cl. CPC F16B 21/071

(57) ABSTRACT

An elastically averaged alignment and retention system includes a first alignment member having an elastically deformable alignment and retention feature, and a second alignment member having an alignment element. The elastically deformable alignment and retention feature has an elastically deformable wall with an opening that defines an entry port, distal and proximal ends, and a retention portion. The alignment element has an alignment projection with distal and proximal ends, the distal end of the alignment projection being larger than the proximal end of the alignment projection. The elastically deformable wall is configured and disposed to interferingly, deformably and matingly engage and retain the alignment projection. Portions of the elastically deformable wall when engaged with the alignment projection elastically deform to an elastically averaged final configuration that aligns the first component relative to the second component in at least two of four planar orthogonal directions.

### FIELD OF THE INVENTION

The subject invention relates to the art of alignment and retention systems, more particularly to an elastically averaged alignment and retention system, and even more particularly to an elastically averaged alignment and retention system that also provides standoffs to the mating parts on which the alignment and retention system is incorporated.

### BACKGROUND

Currently, components, particularly vehicular components such as those found in automotive vehicles, which are to be mated together in a manufacturing process are mutually located with respect to each other by alignment features that are oversized and/or undersized to provide spacing to freely move the components relative to one another to align them without creating an interference therebetween that would hinder the manufacturing process. One example includes two-way and/or four-way male alignment features, typically upstanding bosses, which are received into corresponding female alignment features, typically apertures in the form of holes or slots. There is a clearance between the male alignment features and their respective female alignment features which is predetermined to match anticipated size and positional variation tolerances of the male and female alignment features as a result of manufacturing (or fabrication) variances. As a result, significant positional variation can occur between the mated first and second components having the aforementioned alignment features, which may contribute to the presence of undesirably large variation in their alignment, particularly with regard to the gaps and spacing between them. In the case where these misaligned components are also part of another assembly, such misalignments can also affect the function and/or aesthetic appearance of the entire assembly. Regardless of whether such misalignment is limited to two components or an entire assembly, it can negatively affect function and result in a perception of poor quality.

To align and secure components, the aforementioned male and female alignment features may be employed in combination with separate fastener components that serve to secure the components to each other. In such an assembly, the mating components are located relative to each other by the alignment features, and are fixed relative to each other by the separate fastener components. Use of separate alignment features and fastener components, one for alignment and the other for securement, may limit the effectiveness of each on a given assembly, as the alignment features cannot be employed where the fastener components are employed. Additionally, when the mating female alignment feature creates a through-hole in the associated mating component, neither surface of the associated mating component can be used as a show surface (A surface).

Accordingly, the art of alignment and retention systems can be enhanced by providing an alignment and retention system or mechanism that can ensure precise two-way or four-way alignment and retention of two components via elastic averaging of a single elastically deformable alignment and retention feature disposed in mating engagement with a corresponding single alignment element, and particularly where the mating female alignment feature can provide a show surface (A surface).

### SUMMARY OF THE INVENTION

In one exemplary embodiment of the invention an elastically averaged alignment and retention system includes a first component having a first alignment member and an elastically deformable alignment and retention feature fixedly disposed with respect to the first alignment member, and a second component having a second alignment member and an alignment element fixedly disposed with respect to the second alignment member. The elastically deformable alignment and retention feature has an elastically deformable wall with an opening that defines an entry port, a distal end disposed at a distance from the first alignment member, a proximal end disposed proximate the first alignment member, and a retention portion disposed between the distal end and the proximal end. The alignment element has an alignment projection with a distal end disposed at a distance from the second alignment member, and a proximal end disposed proximate the second alignment member, the distal end of the alignment projection being larger than the proximal end of the alignment projection. The elastically deformable wall is configured and disposed to interferingly, deformably and matingly engage and retain the alignment projection, the distal end of the alignment projection being received by the entry port and retained by the retention portion of the elastically deformable wall. Portions of the elastically deformable wall when engaged with the alignment projection elastically deform to an elastically averaged final configuration that aligns the first component relative to the second component in at least two of four planar orthogonal directions.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 depicts an isometric view of a disassembled assembly of an elastically averaged alignment and retention system having a first component with two elastically deformable alignment and retention features, and a second component with two corresponding alignment elements, in accordance with an embodiment of the invention;

FIG. 2 depicts a cross-section view of the first and second components of FIG. 1 when assembled, cut through the centers of the two elastically deformable alignment and retention features and corresponding two alignment elements, in accordance with an embodiment of the invention;

FIG. 3 depicts a detail view of one of the elastically deformable alignment and retention features and corresponding alignment element of FIG. 2 in a pre-assembled state, in accordance with an embodiment of the invention;

FIG. 4. depicts the same components of FIG. 3, but in a partially assembled state, in accordance with an embodiment of the invention;

FIG. 5 depicts the same components of FIGS. 3 and 4, but in an assembled state, in accordance with an embodiment of the invention;

FIG. 6 depicts a similar arrangement as that depicted in FIG. 5, but with the first component having an aperture as opposed to a blind pocket at the elastically deformable alignment and retention feature, in accordance with an embodiment of the invention;

FIG. 7 depicts an alternative elastically averaged alignment and retention system to that depicted in FIGS. 1-5 having an alignment element formed by an alignment projection having a non-spherical distal end, in accordance with an embodiment of the invention;

FIG. 8 depicts an isometric view similar to that of FIG. 1, but with alternative elastically deformable alignment and retention features, in accordance with an embodiment of the invention; and

FIG. 9 depicts a vehicle having the elastically averaged alignment and retention system of FIG. 1, in accordance with an embodiment of the invention.

### DESCRIPTION OF THE EMBODIMENTS

The following description is merely exemplary in nature and is not intended to limit the present disclosure, its application or uses. For example, the embodiments shown comprise vehicle components but the alignment and retention system may be used with any suitable components to provide elastic averaging for precision location, alignment and retention of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. In some embodiments, the elastically deformable component configured to have the at least one feature and associated mating feature disclosed herein may require more than one of such features, depending on the requirements of a particular embodiment. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, now U.S. Publication No. U.S. 2013-0019455, the disclosure of which is incorporated by reference herein in its entirety. The embodiments disclosed above provide the ability to convert an existing component that is not compatible with the above-described elastic averaging principles, or that would be further aided with the inclusion of an elastically averaged alignment and retention system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled, towed, or movable conveyance suitable for transporting or supporting a burden.

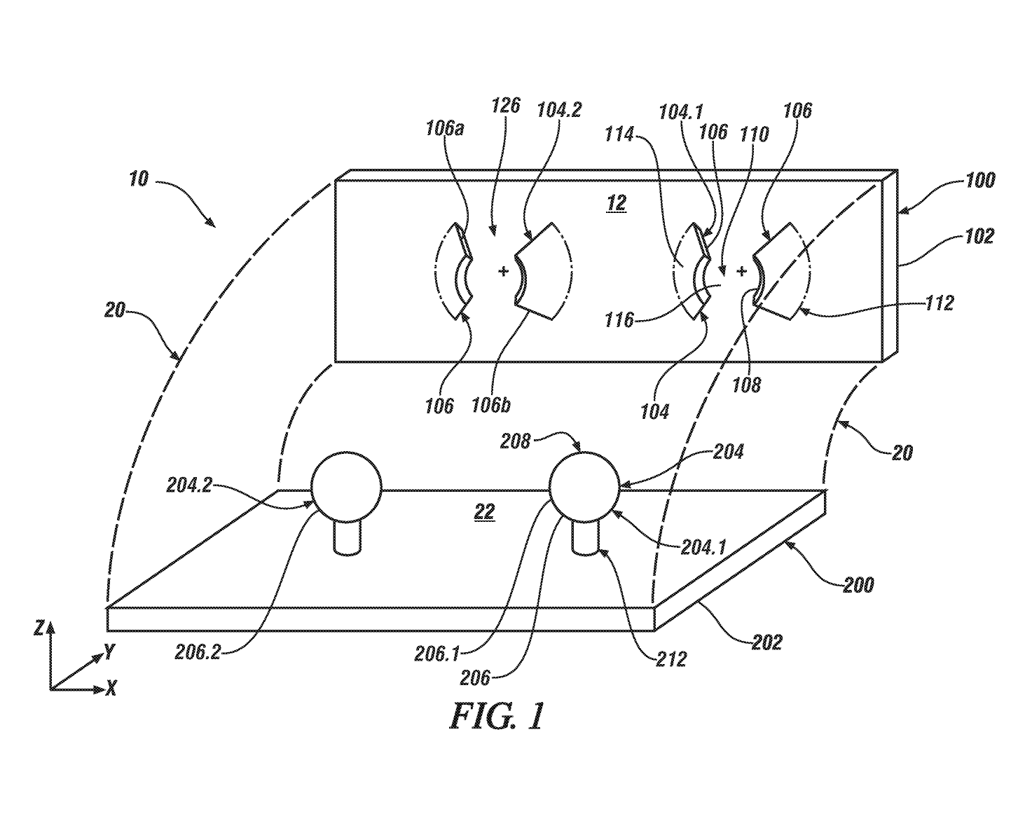

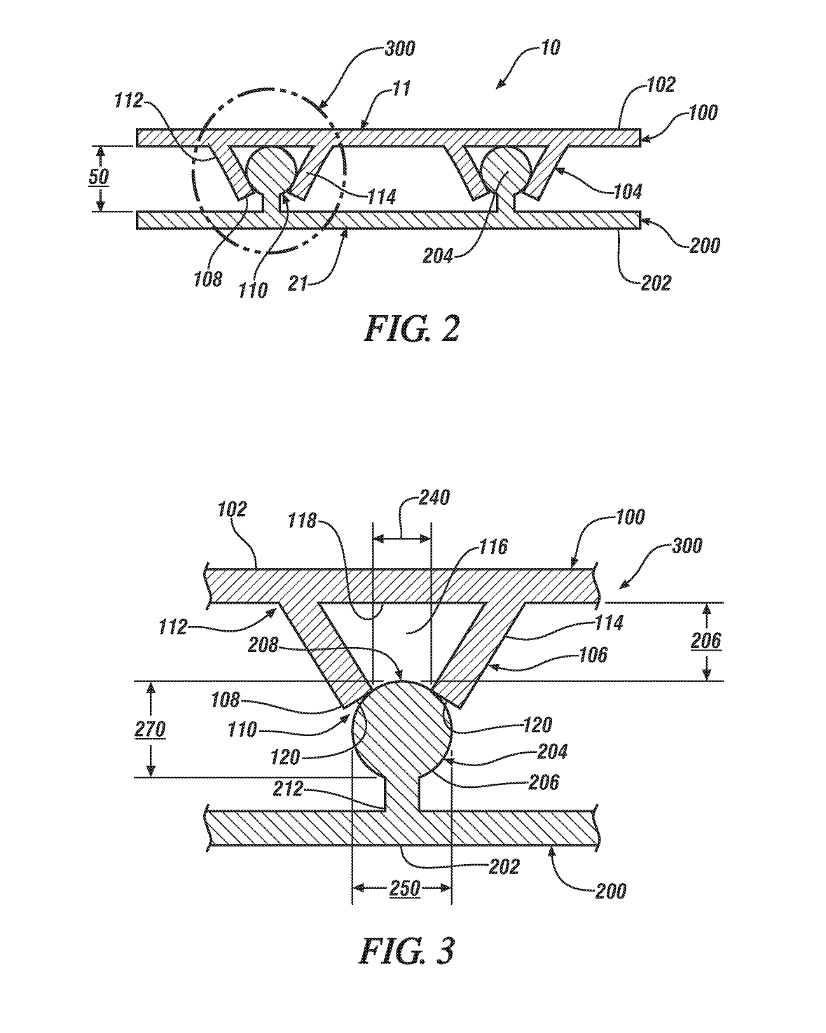

In accordance with an exemplary embodiment of the invention, and with reference to FIGS. 1 and 2, an elastically averaged alignment and retention system 10 includes a first component 100 having a first alignment member 102 and an elastically deformable alignment and retention (EDAR) feature 104 fixedly disposed with respect to the first alignment member 102, and a second component 200 having a second alignment member 202 and an alignment element 204 fixedly disposed with respect to the second alignment member 202. Dashed lines 20 (a fourth line omitted for clarity) represent a direction of assembly between the first and second components 100, 200.

In an embodiment, the EDAR feature 104 has an elastically deformable wall 106 having a distal end 108 disposed at a distance from the first alignment member 102 and defining an opening 110 that forms a distal end entry port (also herein referred to by reference numeral 110), a proximal end 112 disposed proximate the first alignment member 102, and a retention portion 114 disposed between the distal end 108 and the proximal end 112.

In an embodiment, the alignment element 204 is an alignment projection 206 having a distal end 208 disposed at a distance from the second alignment member 202, and a proximal end 212 disposed proximate the second alignment member 202, the distal end 208 of the alignment projection 206 being larger than the proximal end 212 of the alignment projection 206. In an embodiment, the distal end 208 of the alignment projection 206 has a spherical shape.

The elastically deformable wall 106 is configured and disposed to interferingly, deformably and matingly engage and retain the alignment projection 206, where the distal end 208 of the alignment projection 206 is received by the entry port 110 and retained by the retention portion 114 of the elastically deformable wall 106 when the first and second components 100, 200 are assembled together. Portions of the elastically deformable wall 106 when engaged with the alignment projection 206 elastically deform to an elastically averaged final configuration that aligns and retains the first alignment member 102 with the second alignment member 202, and the first component 100 relative to the second component 200, in at least two of four planar orthogonal directions, such as the +/−x-direction and/or the +/−y-direction of an orthogonal coordinate system, for example. Alignment and retention in two planar orthogonal directions is herein referred to as two-way alignment and retention, alignment and retention if four planar orthogonal directions is herein referred to as four-way alignment and retention. The elastically averaged alignment and retention system 10 may be configured as a two-way alignment and retention system or a four-way alignment and retention system. Additionally, the elastically averaged alignment and retention system 10 may be configured as a six-way alignment and retention system by further employing strategic interference in the z-direction between the alignment projection 206 and the elastically deformable wall 106, and between the alignment projection 206 and the first alignment member 102, which will be discussed in more detail below.

For discussion purposes, the mating side of the first alignment member 102 visible in FIG. 1 is labeled 12, and the mating side of the second alignment member 202 visible in FIG. 1 is labeled 22. The non-visible sides of the first and second alignment members 102, 202 that are hidden from view in FIG. 1 are herein referred to by reference labels 11 and 21, respectively. For discussion purposes, a plan view of the elastically averaged alignment and retention system 10 as viewed from side 21 of the second component 200 is herein referred to as a front view, and a plan view of the elastically averaged alignment and retention system 10 as viewed from side 11 of the first component 100 is herein referred to as a rear view.

As previously mentioned, in some embodiments the first component 100 may have more than one EDAR feature 104, and the second component 200 may have more than one corresponding alignment element 204, depending on the requirements of a particular embodiment, where the plurality of EDAR features 104 are geometrically distributed in coordinated relationship to a geometrical distribution of the plurality of alignment elements 204 such that each alignment element 204 is receivable into a respective EDAR feature 204, as illustrated in FIG. 1.

In an embodiment, the elastically deformable wall 106 has a conical shape that transitions from narrow at the distal end 108 to broad at the proximal end 112 to form an undercut shape that defines an interior space 116 of the retention portion 114 (best seen with reference to FIGS. 1, 3 and 5), where the interior space 116 of the retention portion 114 is larger than the entry port 110 when the entry port 110 is un-deformed (see FIGS. 3 and 5, for example). In an embodiment, the elastically deformable wall 106 and the first alignment member 102 form a blind pocket 118 (see FIG. 3, for example).

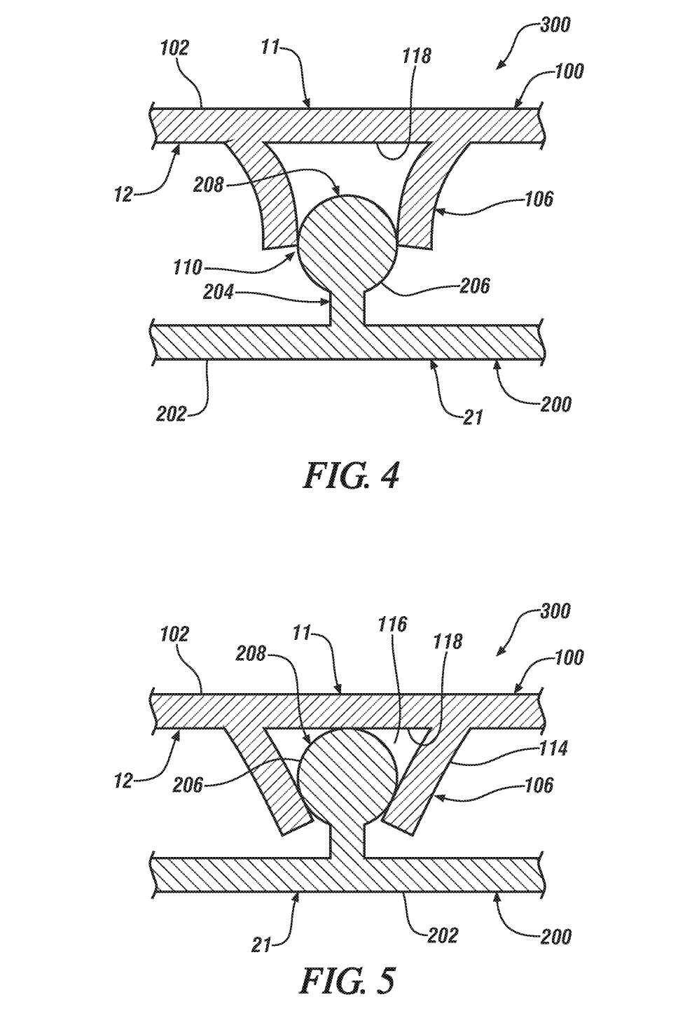

Reference is now made to FIGS. 3-5, which depict detail 300 of FIG. 2 in various stages of assembly (FIG. 3, pre-assembled; FIG. 4, partially assembled; and, FIG. 5, assembled).

At the pre-assembly stage, as depicted in FIG. 3, it can be seen that an embodiment includes an arrangement where the distal end 108 of the elastically deformable wall 106 comprises a lead in chamfer 120, such that the interaction between the distal end 108 of the elastically deformable wall 106 and the spherical shape of the distal end 208 of the alignment projection 206 provides sufficient biasing force to elastically deform the elastically deformable wall 106 to elastically stretch the entry port 110 to receive the spherically shaped distal end 208 of the alignment projection 206. The outer diameter 250 of the spherically shaped distal end 208 of the alignment projection 206 is larger than the contact point width 240 at the entry port 110, which causes an interference condition during assembly that is overcome through elastic deformation as herein described.

At the partially assembled stage, as depicted in FIG. 4, it can be seen that the elastically deformable wall 106 is capable of elastically deforming to such an extent that the entry port 110 can elastically stretch to receive the spherically shaped distal end 208 of the alignment projection 206. It would also be understood that the spherically shaped distal end 208 of the alignment projection 206 may also be capable of elastic deformation, such as by compression of the sphere for example.

At the assembled stage, as depicted in FIG. 5, it can be seen that the elastically deformable wall 106 has elastically relaxed to its original, or close to original, position to form an interior space 116 of the retention portion 114 that captures and retains the spherically shaped distal end 208 of the alignment projection 206.

As depicted in FIGS. 1-5, the elastically deformable wall 106 and the first alignment member 102 form a blind pocket 118, such that the side 11 of the first component 100 along with the side 21 of the second component 200, not visible in FIG. 1 but referenced in FIGS. 2 and 5, are suitable as “A” sides of a finished assembly, where an “A” side is considered to be acceptable for end-user visibility.

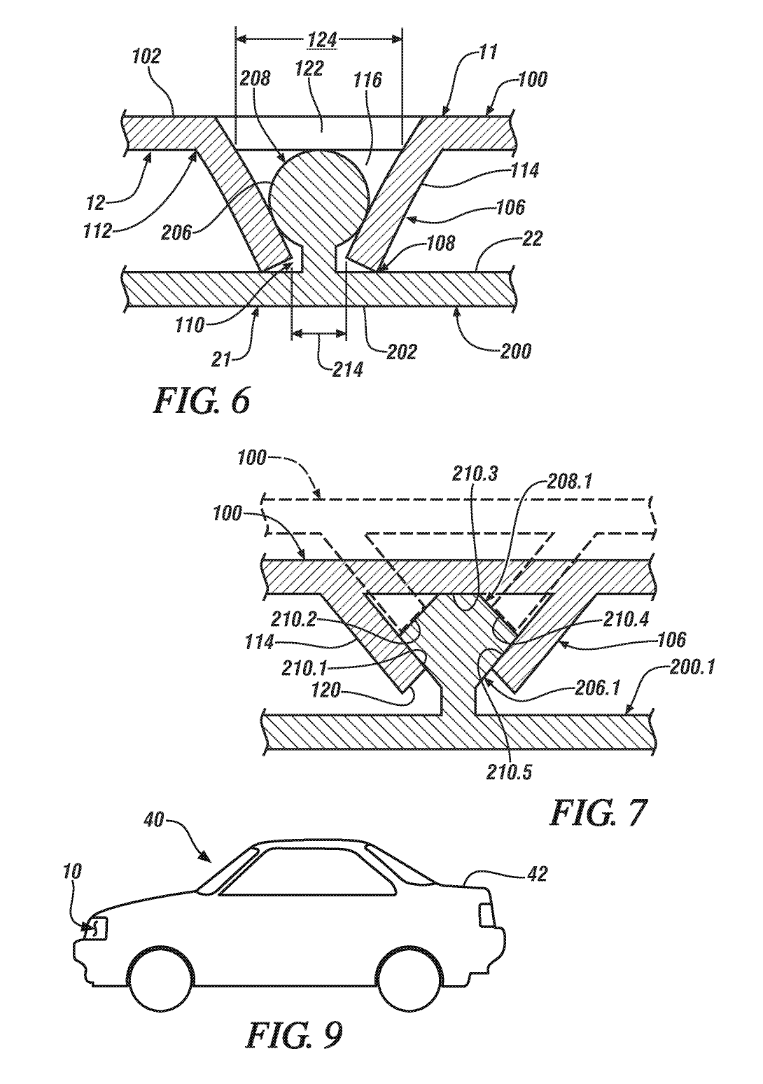

In an embodiment, it may not be necessary for the side 11 of the first component 100 to be visibly acceptable by the end-user, which is referred to as a “B” side. As such, and with reference now to FIG. 6, an embodiment includes an arrangement where the first alignment member 102 has an aperture 122 disposed at the proximal end 112 of the elastically deformable wall 106 and axially aligned with the entry port 110, where the aperture 122 has an opening 124 that is larger than an opening 214 of the entry port 110 when the entry port 110 is un-deformed (see FIGS. 3, 5 and 6, for example, depicting the entry port 110 in an un-deformed state).

While embodiments of the distal end 208 of the alignment projection 206 have been herein described and illustrated having a spherical shape (see FIGS. 1-6, for example), it will be appreciated that the scope of the invention is not so limited and also encompasses any other shape suitable for a purpose disclosed herein. For example, and with reference to FIG. 7, an embodiment includes an arrangement where the second component 200.1 has an alignment projection 206.1 where the distal end 208.1 has a non-spherical faceted shape having a plurality of facets 210.1, 210.2, 210.3, 210.4, 210.5. The first component 100 is illustrated in FIG. 7 in dashed lines (pre-assembled state) and solid lines (assembled state), with section cross-hatching removed for clarity. As can be seen, the angle of the facets 210.2, 210.4 match the angle of the lead in chamfer 120 of the elastically deformable wall 106 to facilitate elastic deformation of the elastically deformable wall 106 during assembly, and the angle of the facets 210.1, 210.5 match the angle of the interior surface of the retention portion 114 to facilitate retention of the alignment projection 206.1 in the assembled state.

In the assembled state, see FIGS. 2, 5, 6 and 7 for example, the EDAR features 104 and alignment elements 204 may serve as standoffs that keep the first and second components 100, 200 at a defined gap 50 (see FIG. 2) away from each other. To control the gap 50, the distal end 208 of the alignment projection 206 may seat against the side 12 of the blind pocket 118 formed by the elastically deformable wall 106 and the first alignment member 102, as depicted in FIG. 5, or the distal end 108 of the elastically deformable wall 106 may seat against the side 22 of the second component 200, as depicted in FIG. 6, or a combination of the foregoing gap control means may be employed. From the foregoing, it will be appreciated that the standoffs are not separate features, but are an integral part of the EDAR features 104 and/or alignment elements 204. With reference to the pre-assembled state depicted in FIG. 3 that results in the assembled state depicted in FIG. 5, an embodiment includes an arrangement where the height 270 of the spherically shaped distal end 208 of the alignment projection 206 is larger than the contact point height 260 within the interior space 116 of the retention portion 114, which causes an interference condition in the assembled state depicted in FIG. 5 that provides the aforementioned control of gap 50.

As previously mentioned, in some embodiments the first component 100 may have more than one EDAR feature 104, and the second component 200 may have more than one corresponding alignment element 204. For example, and with reference back to FIG. 1, the elastically averaged alignment and retention system 10 is configured with the first component 100 having a first and a second EDAR feature 104.1, 104.2 spaced apart from each other, and with the second component 200 having a first and a second alignment element 204.1, 204.2 spaced apart from each other. The first and second EDAR features 104.1, 104.2 are geometrically distributed with respect to the first and second alignment elements 204.1, 204.2 such that portions of the elastically deformable walls 106 of respective ones of the first and second EDAR features 104.1, 104.2, when engaged with respective ones of the alignment projections 206.1, 206.2 of the respective first and second alignment elements 204.1, 204.2, elastically deform to an elastically averaged final configuration that aligns the first alignment member 102 with the second alignment member 202 in at least two of four planar orthogonal directions.

With reference still to FIG. 1, an embodiment of the invention includes an arrangement where the elastically deformable wall 106 has two wall segments 106a (first wall segment), 106b (second wall segment), but may have more than two, and in an embodiment has more than one wall segment.

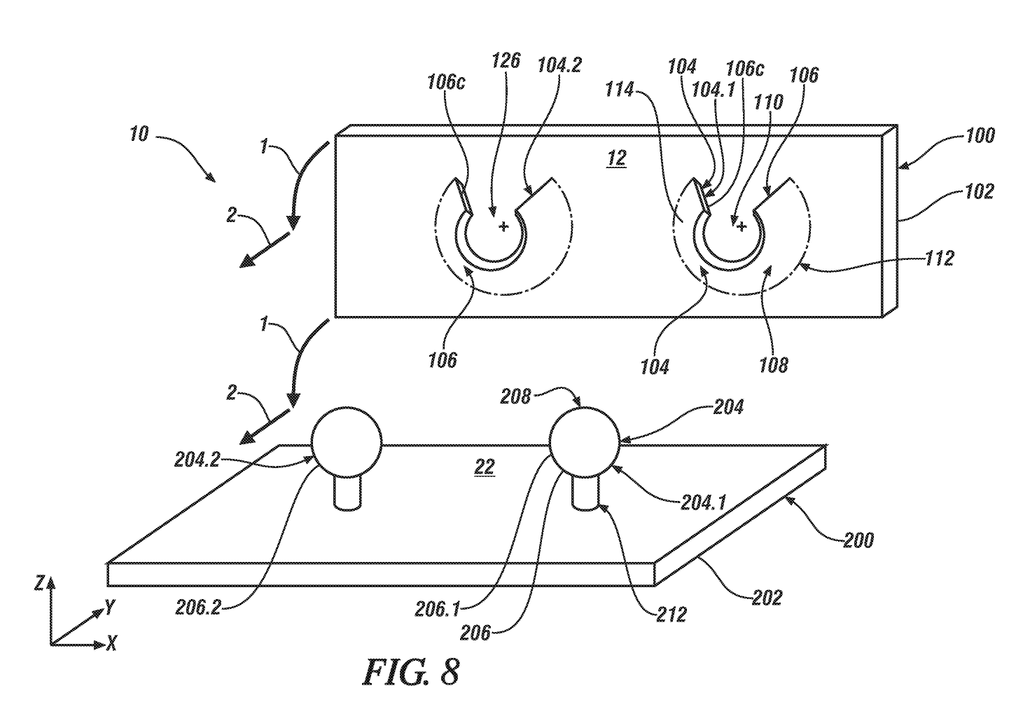

Alternatively, and with reference now to FIG. 8, an embodiment includes an arrangement where the elastically deformable wall 106 is a single continuous wall segment 106c. That is, the first and second wall segments 106a, 106b as depicted in FIG. 1 are joined together to form the single continuous wall segment 106c as depicted in FIG. 8, leaving an opening 126, also herein referred to as a side entry port, in the wall segment 106c sized to elastically deform to receive the EDAR feature 104 when inserted from the side. In an embodiment, the single wall segment 106c has the same conical shape as the first and second wall segments 106a, 106b depicted in FIG. 1. Arrows 1 and 2 in FIG. 8 illustrate first and second relative movements between the first and second components 100, 200 during assembly of the first and second components 100, 200, where the first relative movement, arrow 1, is a rotation of the first component 100 that orients side 12 of the first component 100 parallel with side 22 of the second component 200, and the second relative movement, arrow 2, is a sideways movement that engages the EDAR features 104 with the corresponding alignment elements 204 via elastic deformation of the single wall segment 106c at the opening 126. By comparing FIGS. 1 and 8, it will be appreciated that the alignment projection 206 may pushed into engagement with the EDAR feature 104 via the entry port 110, herein referred to as a top-down assembly, or slid into engagement with the EDAR feature 104 via the opening (side entry port) 126, herein referred to as a sideways assembly. It will also be appreciated that the first and second components 100, 200 of the embodiment depicted in FIG. 1, may be assembled via the top-down assembly approach or the sideways assembly approach, as evidenced by the inclusion of both reference numerals 110 and 126 in FIG. 1.

While FIG. 1 illustrates two of the same EDAR features 104 having a two wall segments 106a, 106b, and FIG. 8 illustrates two of the same EDAR features 104 having a single continuous wall segment 106c, it will be appreciated that the scope of the invention also encompasses an embodiment that employs both types of EDAR features and more than two EDAR features.

In view of all that is disclosed, illustrated, described, and incorporated by reference herein, it will be appreciated that the scope of the invention is not limited to only the use of the herein disclosed EDAR features 104 and corresponding alignment elements 204, but also encompasses the use of EDAR features 104 and corresponding alignment elements 204 in combination with other elastic averaging alignment features, male or female.

In view of all of the foregoing, and with reference now to FIG. 9, it will be appreciated that an embodiment of the invention also includes a vehicle 40 having a body 42 with an elastically averaged alignment system 10 as herein disclosed integrally arranged with the body 42. In the embodiment of FIG. 9, the elastically averaged alignment system 10 is depicted forming at least a portion of a front grill of the vehicle 40. However, it is contemplated that an elastically averaged alignment system 10 as herein disclosed may be utilized with another feature of the vehicle 40, such as interior trim for example, where the first component 100 forms a first portion of the vehicle 40, and the second component 200 forms a second portion of the vehicle 40.

When the first component 100 and second component 200 are components of a vehicle, an advantageous assembly results because the retaining force, together with the elastic deformation of the alignment features that has these parts in pressing contact already, reduces the tendency of the components to vibrate or rattle against one another, and thus improves the noise, vibration and harshness (NVH) characteristics of the components and the vehicle in which they are installed. The selective engagement of the EDAR feature 104 and the alignment element 204 also provides a stiffened assembly of the first component 100 and second component 200 when the first and second components are mutually mated to each other, including a stiffness that is greater than that realized by using the alignment features alone, since the retaining force between the first component and second component increases the stiffness of the assembly, for example.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment and retention system, comprising:
a first component comprising a first alignment member and an elastically deformable alignment and retention feature fixedly disposed with respect to the first alignment member, the elastically deformable alignment and retention feature comprising an elastically deformable wall having an opening that defines an entry port, and having a distal end disposed at a distance from the first alignment member, a proximal end disposed proximate the first alignment member, and a retention portion disposed between the distal end and the proximal end;
a second component comprising a second alignment member and an alignment element fixedly disposed with respect to the second alignment member, the alignment element comprising an alignment projection having a distal end disposed at a distance from the second alignment member, and a proximal end disposed proximate the second alignment member, the distal end of the alignment projection being larger than the proximal end of the alignment projection;
wherein the elastically deformable wall is configured and disposed to interferingly, deformably and matingly engage and retain the alignment projection, the distal end of the alignment projection being received by the entry port and retained by the retention portion of the elastically deformable wall; and
wherein portions of the elastically deformable wall when engaged with the alignment projection elastically deform to an elastically averaged final configuration that aligns the first component relative to the second component in at least two of four planar orthogonal directions.

2. The elastically averaged alignment and retention system of claim 1, wherein the entry port is a distal end entry port disposed at the distal end of the elastically deformable wall.

3. The elastically averaged alignment and retention system of claim 1, wherein the entry port is a side entry port disposed at a side of the elastically deformable wall.

4. The elastically averaged alignment and retention system of claim 1, wherein the elastically deformable wall has a conical shape that transitions from narrow at the distal end to broad at the proximal end.

5. The elastically averaged alignment and retention system of claim 1, wherein the elastically deformable wall has an undercut shape that defines an interior space of the retention portion, the interior space of the retention portion being larger than the entry port when the entry port is un-deformed.

6. The elastically averaged alignment and retention system of claim 1, wherein the elastically deformable wall and the first alignment member form a blind pocket.

7. The elastically averaged alignment and retention system of claim 2, wherein the first alignment member comprises an aperture disposed at the proximal end of the elastically deformable wall and axially aligned with the entry port, the aperture having an opening larger than an opening of the entry port when the entry port is un-deformed.

8. The elastically averaged alignment and retention system of claim 1, wherein the elastically deformable wall has more than one wall segment.

9. The elastically averaged alignment and retention system of claim 1, wherein the distal end of the elastically deformable wall comprises a lead in chamfer.

10. The elastically averaged alignment and retention system of claim 1, wherein the distal end of the alignment projection comprises a spherical shape.

11. The elastically averaged alignment and retention system of claim 1, wherein distal end of the alignment projection comprises a non-spherical faceted shape.

12. The elastically averaged alignment and retention system of claim 1, wherein the elastically deformable alignment and retention feature is a first of the elastically deformable alignment and retention feature, the alignment element is a first of the alignment element, and further wherein:
the first component further comprises a second of the elastically deformable alignment and retention feature fixedly disposed with respect to the first alignment member and spaced apart from the first elastically deformable alignment and retention feature;
the second component further comprises a second of the alignment element fixedly disposed with respect to the second alignment member and spaced apart from the first alignment element; and
the first and second elastically deformable alignment and retention features are geometrically distributed with respect to the first and second alignment elements such that portions of the elastically deformable walls of respective ones of the first and second elastically deformable alignment and retention features, when engaged with respective ones of the alignment projections of the respective first and second alignment elements, elastically deform to an elastically averaged final configuration that further aligns the first component relative to the second component in at least two of four planar orthogonal directions.

13. The elastically averaged alignment and retention system of claim 1, wherein the first component comprises more than one of the elastically deformable alignment and retention feature and the second component comprises more than one of the alignment element, the more than one elastically deformable alignment and retention features being geometrically distributed with respect to respective ones of the more than one alignment elements, such that portions of the elastically deformable alignment and retention feature of respective ones of the more than one elastically deformable alignment and retention features, when engaged with respective ones of the more than one alignment elements, elastically deform to an elastically averaged final configuration that further aligns the first component relative to the second component in at least two of four planar orthogonal directions.

14. The elastically averaged alignment and retention system of claim 1, wherein:
the first and second components are retained relative to each other with a defined gap therebetween, the defined gap being controlled by a standoff formed by the distal end of the alignment projection engaging with a surface of the first component.

15. The elastically averaged alignment and retention system of claim 1, wherein:
the first and second components are retained relative to each other with a defined gap therebetween, the defined gap being controlled by a standoff formed by the distal end of the elastically deformable wall engaging with a surface of the second component.

16. The elastically averaged alignment and retention system of claim 1, wherein:
the first component comprises a first portion of a vehicle; and
the second component comprises a second portion of the vehicle.
